(19) United States
(12) Patent Application Publication
(10) Pub. No.: US 2016/0196267 A1
(43) Pub. Date: Jul. 7, 2016

(54) CONFIGURING A WEB FEED

(71) Applicant: Linkedln Corporation, Mountain View, CA (US)

(72) Inventors: Axel R. Hansen, San Francisco, CA (US); Jonah L. Varon, San Francisco, CA (US); Shane S. Hill, San Francisco, CA (US)

(73) Assignee: Linkedln Corporation, Mountain View, CA (US)

(21) Appl. No.: 14/589,843

(22) Filed: Jan. 5, 2015

(51) Int. Cl. G06F 17/30; H04L 12/26; H04L 29/08

(52) U.S. Cl. CPC G06F 17/3053; H04L 67/02; H04L 43/16

(57) ABSTRACT

A system, apparatus, and method are provided for configuring web feeds for users/subscribers. A user identifies a topic of interest, which may be a person, organization, event, place, concept, or other thing. A content processor analyzes content items received from a multitude of publishers' feed to identify their topics. A relevance score regarding each associated topic is calculated for each of the received items and, for each user that subscribed to the topic, the item's relevance score is compared to a user-specific threshold relevance score to determine whether to add it to the user's feed. The threshold relevance score for a topic for a user is computed based on factors such as the average relevance scores of the topic's content items, the standard deviation, the user's relationship with the topic, a target frequency with which items corresponding to the topic should be offered to the user, etc.

### BACKGROUND

This disclosure relates to the field of computer systems. More particularly, a system, apparatus, and methods are provided for populating a web feed for delivery to a user and, more particularly, to selecting content to include in the feed and/or ordering the selected content.

Web feeds, such as RSS (Really Simple Syndication) feeds and Atom feeds, are mechanisms for publishing content to interested people (users, subscribers) without requiring them to visit the source of the feed (e.g., a web site, a blog) and manually access or retrieve the content, although they may be able to do so in order to see the same content and/or additional content.

A provider of a web feed, however, risks user fatigue if it provides a subscriber with too many content items, too many items that are similar, too many items regarding one topic or subject, or otherwise provides the user with too many items that do not interest the user.

### DESCRIPTION OF THE FIGURES

FIG. 1 is a block diagram depicting a system for configuring a web feed, in accordance with some embodiments.

FIG. 2 is a flow chart illustrating a method of configuring a web feed, in accordance with some embodiments.

FIG. 3 depicts an apparatus for configuring a web feed, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, apparatus, and methods are provided for configuring or tailoring a web feed for a specific user or recipient. Each feed delivered to a user contains content items that match, mention, or discuss a topic, subject, theme, or other thing identified or selected by the user. For example, a user may identify one or more persons, organizations, places, activities, and so on, that interest him, and his feed will be populated with related content. For simplicity, the term “topic” is used to refer to a subject, theme, focus, concept, event, name (e.g., of a person, place, or thing), etc., that is used to determine which users (if any) should receive a particular content item, to order items within a feed, and/or for other purposes.

In these embodiments, various preferences of feed recipients are learned from their activity and/or by querying them. These preferences include their preferred topics, preferred types or formats of content items, how often they would like to receive (or should receive) a particular type of content item (e.g., in terms of topic(s) and/or format of the items), and/or other parameters.

Also, in these embodiments, a user may access his or her web feed in multiple ways or via multiple channels or platforms. For example, a user may receive messages (e.g., via electronic mail, via instant message, via some other means) on a periodic basis (e.g., once a day, twice a day) that include any number of content items from the feed, links to the feed, and/or links to individual content items. In addition, he or she may be able to visit a web site (e.g., a site affiliated with a creator or publisher of the feed) and access the same content and/or additional items. For example, when he visits the site a user may be able to see, in advance of the next periodic message, the content items that the publisher has deemed sufficiently relevant or interesting to him, may be able to access items that were considered relevant or interesting to him but not sufficiently so to include them in the most recent periodic message, and/or other items. In addition, a mobile application may be tailored to allow the user to access the feed and/or individual items from a mobile device such as a smartphone, tablet computer, etc.

In embodiments in which a user may access his or her feed in multiple formats and/or via different platforms (e.g., electronic mail, online), items in the feed may be presented the same way (or in substantially the same way) via each format or platform. For example, the order in which a collection of items is presented when delivered via electronic mail may also apply when the feed is later accessed online (e.g., via a web site). In particular, once the items are provided to the user in some certain order (whether via electronic mail, online, or in some other format), the order of those items may become static and remain static thereafter.

As additional content items are selected or identified for inclusion in the feed, they may not be finally ordered until they are to be delivered in some format (e.g., via electronic mail or online). Thereafter, they too become static. Thus, if the user accesses the feed online, he or she will see previous items in their static order, and any new items that were selected for him or her will be ordered and presented at that time (e.g., according to relevance), and thereafter become static.

In these embodiments, the user can easily determine what he or she has seen before in the feed, and can easily find a particular item that he or she would like to access again. This differs from feeds that may change the order in which content items are presented from one visit to another, and also from feeds that present content strictly in a chronological (or reverse chronological) fashion, without any consideration as to how relevant the content is, or how the content may have been presented previously.

In some embodiments, in order for a given content item to be included in particular user's feed, it must have at least a threshold relevance for or association with the user, and/or with relation to the item's topic. As described further below, one threshold relevance score or measure may apply to some or all content items considered for inclusion in one feed.

In some implementations, however, in which a user identifies multiple different topics, separate threshold relevance scores may apply to each topic to determine whether a particular content item having or associated with that topic will be included in the user's feed. For example, a system or service that provides users with news articles and/or other content that mentions one or more specific individuals may apply different threshold relevance scores for each individual to determine whether a given article (or other item) should be included in a user's feed.

In these embodiments, a threshold relevance score or measure to apply for a user may be configured with specific input from that user, and/or may be configured or reconfigured automatically based on the user's behavior—such as how often he opens a content item regarding a given topic and/or other topics, how often he visits the service's or system's web site to view additional content—and/or other factors. In particular, a threshold relevance score applied for a topic of interest to a user may be based on a target frequency of delivery to the user of content associated with that topic.

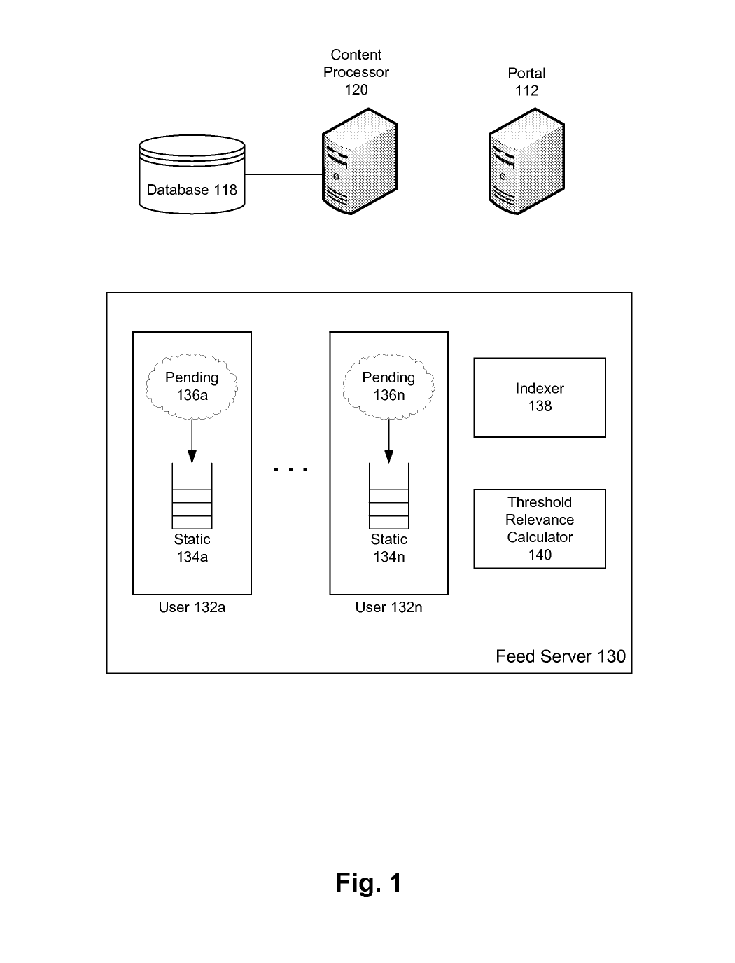

FIG. 1 is a block diagram depicting a system for configuring a web feed, according to some embodiments. Illustratively, the system may be implemented as, or as part of, a data center that supports the provision of web feeds to subscribers, members, and/or other users. The system may be part of a larger system that provides additional applications or services, such as a professional social networking system, in which case at least some users of the system are members (and users) of the social networking system.

Portal 112 of the illustrated system may be or may include one or more web servers and/or other interfaces for receiving online connections from users of the system (e.g., to access content of their feeds), and may also (or instead) receive content from publishers such as news organizations, blogs, and other online publications. In some alternative embodiments, a web server may be deployed separately from portal 112.

Content processor 120 processes received content items to facilitate determinations as to which subscribers or users, if any, the items should be provided to via their feeds. For example, content processor 120 may process each item to one or more corresponding topics (e.g., to identify one or more people, places, and/or things mentioned in the item). The content processor may then store the items (or links to the items) in database 118, and also (or instead) forward items or metadata regarding the items to feed server 130.

U.S. patent applications Ser. Nos. 14/565,158 and 14/565,165, entitled “Disambiguating Personal Names” and “Disambiguating Organization Names,” respectively, which were filed Dec. 9, 2014, describe the operation of illustrative content processors, and are incorporated herein by reference.

Feed server 130 is responsible for populating users' feeds, de-duplicating items within each user's feed as necessary, ordering items within each feed, and/or performing other actions.

Within feed server 130, separate static queues 134 and pending queues 136 are maintained for each user, member, or subscriber 132 (e.g., for users 132a to 132n). In particular, for each user (e.g., user 132a), the system maintains a static queue (e.g., static queue 134a) that contains content items (or links to items) that were previously presented or offered to the user via his feed (or via one of his feeds if he receives multiple feeds from the system), in the same order in which they were presented or offered.

In addition, the system maintains a pending queue (e.g., pending queue 136a) that stores additional/new items (i.e., items not included in static queue 134a) that were identified or processed by the feed server after the most recent feed-related interaction between the system and the user. For example, after the user navigates to a web site associated with the system and views his feed, or after the system dispatches feed content to him (e.g., via electronic mail), and until he again navigates to the site or until the system again dispatches feed content, new items deemed (sufficiently) relevant to him will be maintained in pending queue 136a. When he does navigate to the site or when the system dispatches additional feed content, and as described below, his pending queue will be processed, queued items will be sorted, and the sorted items will be added to his static queue.

Indexer 138 (e.g., a hardware module or collection of computer-executable instructions) receives content items (e.g., from content processor 120 and/or an external source or processor) and, for each user for which it is deemed to have sufficient relevance, determines whether it already exists in the user's queues (or at least the pending queue) and, if not, adds it to the pending queue.

Further, when the user visits the system's site or interface for accessing feed content, or when the system assembles a message containing feed content to send to the user, the indexer sorts the pending queue contents (e.g., by relevance, topic, and/or other factors), de-duplicates as necessary against the static queue, and adds (e.g., prepends) the contents of the pending queue to the static queue.

To help determine which user feeds, if any, a given content item should be forwarded to, indexer 138 calculates the relevance of the item to the topic(s) ascribed to the item. For example, content processor 120 may forward or report items to the indexer along with one or more topics that describe the item. As described in more detail below, the indexer then calculates a measure of just how closely the item and the topic are aligned or related. For example, indexer 138 may include executable instructions or a relevance calculator module configured to calculate the relevance of content items regarding their corresponding topics. In some embodiments, content processor 120 may forward content items directly to users' pending queues based on which users have subscribed to which topics.

Threshold relevance calculator 140 (e.g., a hardware module or collection of computer-executable instructions) calculates and/or maintains (e.g., updates, recalculates) threshold relevance scores for each user regarding each topic of the user's feed(s). Alternatively, one threshold relevance score may apply to multiple (or all) topics. Individual content items may then be included in a user's feed if their relevance scores exceed the applicable threshold score(s). This comparison may be made by indexer 138 or relevance calculator 140.

In some embodiments, an initial threshold relevance score for a user (or a set of initial scores) may be copied from a default score (or default scores) or, if there is sufficient knowledge of the user, may be calculated based on that knowledge. In particular, a threshold relevance score may (or may not) be regularly, irregularly, or periodically modified based on the user's observed behavior, on preferences that he expresses, on other users' behavior and/or preferences, and/or other applicable factors. Calculation of threshold relevance scores is discussed in more detail below.

Functionality of the system of FIG. 1 may be distributed among its components in an alternative manner, such as by merging or dividing functions of one or more components, or may be distributed among a different collection of components. Yet further, while depicted as separate and individual hardware components (e.g., computer servers) in FIG. 1, one or more of portal 112, content processor 120, and feed server 130 may alternatively be implemented as separate software modules executing on one or more computer servers. Thus, although only a single instance of a particular component of a system may be illustrated in FIG. 1, it should be understood that multiple instances of some or all components may be utilized.

In some embodiments, indexer 138 of the system of FIG. 1, or some other component of the system, applies any or all of multiple factors in order to calculate a relevance score for a particular content item in regard to a topic associated with the item. The topic may be a person, place, or thing mentioned in or related to the item, may be a concept, an event, or some other thing addressed in the item, or may be otherwise indicative of the item's content.

One factor that may be considered is the number of times the topic of a content item is mentioned in the item. In different implementations, this factor may be computed differently, to require (or not require) the full topic (e.g., the full name of an individual) to be mentioned, to count partial mentions of the topic (e.g., a first name or last name of an individual), may involve internationalization or normalization of the topic and/or content of the item (e.g., to adjust spelling, whitespace, capitalization), etc.

For each content item, this factor may be expressed as an integer value identifying the number of mentions of the item's topic, in the item, and may be calculated by a system component such as indexer 138 of feed server 130, or by content processor 120 as it identifies each item's topic(s).

A second factor that may be considered is the “quality” of the item's source (e.g., a content publisher, an author, a producer). For news articles, for example, a respected national publication such as the New York Times may be rated as higher quality than an amateur author, a blogger, or a portal site that merely distributes content authored or originated by others. This measure of quality may be generated using subjective and/or objective observations.

In some implementations, the quality factor for a web-based content provider is based on a measure of the amount of traffic experienced by the provider, in terms of page views, time on site, unique visitors, and/or other metrics. Thus, an initial value for a provider's source quality factor may be a relative ranking of the provider's popularity in terms of online traffic. An illustrative range of values for the source quality factor is an integer within the range of 0 through 6, in which case each provider of content items processed by a system for configuring web feeds described herein is assigned one of seven possible values based on the provider's popularity. A third-party tool or service may provide the popularity measures.

However, an initial source quality factor value may be modified subjectively, by a human operator for example. Thus, as indicated above, the quality score of a respected content publisher may be increased to reflect its perceived quality (even if its popularity or web traffic is lower than other publishers'), while the quality score of a more popular site or provider may be decreased if its reputation (e.g., for objectiveness, for veracity) is lower than its initial score indicates, if it does not actually originate content (e.g., it is just a portal that aggregates content originated by other entities), and/or for some other reason.

Further, some providers may be eliminated from scoring (and their content excluded from users' feeds), or automatically or manually assigned the lowest possible value (e.g., zero), because they provide pornography, spam, and/or other undesired content, or because their content is more likely to carry computer-based threats such as viruses. A blacklist may be maintained to identify undesirable providers.

A third illustrative factor for calculating a relevance score for a particular content item regarding a particular topic is the “cluster size” of the item. The cluster size of an item is intended to provide a measure of how many different content items (e.g., news articles, blog entries) cover the same subject matter regarding the topic. Thus, if the topic is a name of an individual (or a place or other thing), multiple different writers or other content producers may generate items regarding some occurrence, event, or story about the individual, and some or all of them may belong to the same cluster. In short, items that have very similar linguistic profiles, and use many of the same words, for example, may be deemed to occupy the same cluster.

In some implementations, calculating the cluster size of a given textual content item (or textual portion of a multimedia item) requires consideration of language used in other content items having the same topic, over some period of time. For example, by linguistically analyzing the textual content of content items that have a given topic and that are received during this time period (e.g., 1 week, 2 weeks, 1 month), the frequency of different words and phrases can be determined.

Over the period of time, some words/phrases will be used more frequently than others. For example, new items that address a new event involving the topic will likely use words that differ from previous items having the same topic.

When a new item is received, it is analyzed and can then either be included in a cluster associated with some previous content item or serve as the first item in a new cluster if its analysis sets it apart. A cluster may be of any size greater than or equal to 1, but may be capped. In other words, clusters greater in size than some cut-off (e.g., 20, 50, 100) may not have any more impact than clusters that are right at the cut-off size, and hence cluster size may not be counted past a selected cut-off value (e.g., 20), which may differ from one topic to another.

The greater the difference between the content of a new item and that of existing items, such as when a new and significant event occurs that causes different words and phrases to be used, the more likely it is that the new item is separate and distinct from existing clusters (or at least from clusters that have been used within the current time period). Thus, when analyzing a content item, new words and phrases may be given more weight than words and phrases found to have been relatively common during the time period, which will help set new items apart.

Over time, a cluster associated with a particular occurrence, event, or issue regarding a topic may divide into multiple clusters. For example, one given cluster may be spawned because of a significant event regarding a topic. Then, as individual nuances or aspects of the event are explored in greater detail in subsequent content items, separate (sub-) clusters may be formed. The words and phrases that caused the given cluster to spawn will have less impact (i.e., because they will now be more common), and different words and phrases that are specific to the different aspects of the event will be more significant.

Clustering, and determining cluster size, may be performed for one, some, or all topics within a given content item. Therefore, when topics correspond to individuals, a particular news article that mentions multiple people may cause the cluster size factor to be calculated for the article for each person.

Cluster size may be expressed as an integer value that identifies the number of items in the cluster. As indicated above, cluster size may be capped.

A fourth factor that may affect the relevance score of a content item is whether the topic of the item is mentioned in the item's title (for those items that have titles). For example, when topics are individual people, an article that mentions a person's name will have a higher relevance score (for individuals that have that name) than it would otherwise.

Yet other factors may be considered when calculating a relevance score for a particular content item, and different sets of factors may be used in different embodiments. When the operable factors are determined for a given content item, they may be normalized, weighted, and/or manipulated in some other way before being added or otherwise combined to yield the final relevance score of the item.

The exemplary factors described above (cluster size, source quality, number of mentions of a topic, whether a topic is mentioned in a title) may be weighted differently in different embodiments. Illustratively, however, the number of mentions of a topic and the determination as to whether the topic is identified in a title may be weighted most heavily, with cluster size and source quality carrying less weight (e.g., approximately half the weight of the others).

Calculating a threshold relevance score of a user or subscriber for one or more of the user's topic (e.g., for all topics from one source), to be compared with relevance scores of content items within those topics to determine which (if any) to add to the user's feed, may differ from one embodiment to another.

In some embodiments, the inputs or metrics used to compute a threshold relevance score for filtering content items within a topic to which a user subscribes include one or more of the following: the average relevance score of the topic's corresponding content items over some time period (i.e., items categorized within the topic), the standard deviation from that average of a given item, the average number of times a topic is mentioned in its corresponding content items, and the target frequency with which the user should receive items associated with the topic. In other embodiments, other inputs may be applied instead of or in addition to these.

To generate these inputs, content items (or summaries or analyses of the items) are retained for some period of time (e.g., 2 weeks, 1 month, 3 months). The average relevance score is thus the average relevance score of retained items that correspond to the topic, the standard deviation can be readily derived from the same data, and a new item's variance from the standard deviation can be easily obtained. Similarly, the average number of times each of the retained items mentions the topic can be readily calculated from the retained information. These inputs or metrics thus depend only upon the topic and its corresponding content items, and not on any particular user or subscriber.

The target frequency with which a user should receive items within a particular topic, however, may depend upon the user's behavior and/or preferences (learned and/or stated) the nature of the relationship between the user and topic (if any), and/or other factors, and thus may differ from one user to another. For example, one user may wish to see, on average, one content item per day regarding a particular topic. A second user may wish to see, on average, one content item per week regarding the same topic. The system may determine on its own that a third user should see two content items per week for the topic. Feeding these users more items than they desire may decrease their enjoyment of the feed or even cause them to unsubscribe or to stop accessing it.

Based on the target frequency (or, alternatively, target rate) of delivery of content items having a given topic to a given user, the system can calculate the threshold relevance score that will, on average, provide the target frequency of delivery over time. For example, if an average of 100 content items per month are received for a first topic, and a first user's target delivery rate/frequency for the first topic is one item per week, then the threshold relevance score for the first user and the first topic should be such that only 4 items per month, on average, will have relevance scores high enough to qualify for addition to the user's feed. Actual calculation of the threshold relevance score may draw upon the standard deviation observed for the topic's content items.

Any suitable method may be used to select or configure a target frequency of delivery of content to a given user, and different targets may be selected or configured for each topic included in the user's feed. In addition, a target frequency may be automatically adjusted over time, as the user's behavior changes, as the user's relationship with the topic changes, as characteristics of the topic change (e.g., average relevance score, standard deviation), in response to specific guidance from the user, etc.

Thus, in some embodiments in which topics are people and content items in a user's feed are items that mention specific people, an initial target frequency for the user may depend on the user's association with those people. For example, the target frequency for a particular person/topic may be higher if the user and the person are friends in a social network site or system, are connected within a professional social network site or system (such as that provided by LinkedIn® Corporation), if either of them are included in the other's address book (or other collection of contacts), if electronic mail (or other messages) are known to be exchanged between them, if the user “follows” or subscribes to information regarding and/or published by the person.

In one illustrative embodiment, a default target frequency of delivery of content items for a given topic individual for a given recipient/user is once per week for each documented connection between the user and the topic individual. Therefore, if they are connected in the LinkedIn professional social networking system, for example, the default target frequency will be one item per week. If they are also connected via two other social media applications, systems, or services, the target frequency may increase to three items per week.

If the user and the topic individual are identified as relatives, close friends, or in some other close relationship, in one or more social media applications, the target frequency may increase even more. If the user's address book or contact list includes the topic individual (e.g., within a mail or messaging application of a professional social networking system), and/or vice versa, this may also increase the target frequency of delivery by some number of items per week (e.g., one, two).

Contrarily, if the user simply visited a web site associated with the system of FIG. 1, and used a dialog box or search utility to identify the topic individual, then a default target frequency of delivery may be less than one item per week, such as one item per month or one item every two weeks.

Because relationships between users and topic individuals may be regularly or periodically re-evaluated, a target frequency may change as a relationship grows or shrinks. Also, if a user is observed to consume (e.g., read) every item regarding a particular topic individual, or virtually every item, the target frequency of delivery may increase. Similarly, if a user fails to consume items regarding a first topic individual, but does consume items regarding other individuals, the target frequency of delivery for the user for the first topic individual may decrease. Increases and/or decreases may be linear and incremental (e.g., increasing or decreasing by a set number of items), may be exponential (e.g., if a user and topic individual are found to be close relatives), and/or may change according to some multiplier instead of a fixed number of items (e.g., 0.5, 1.2, 1.5).

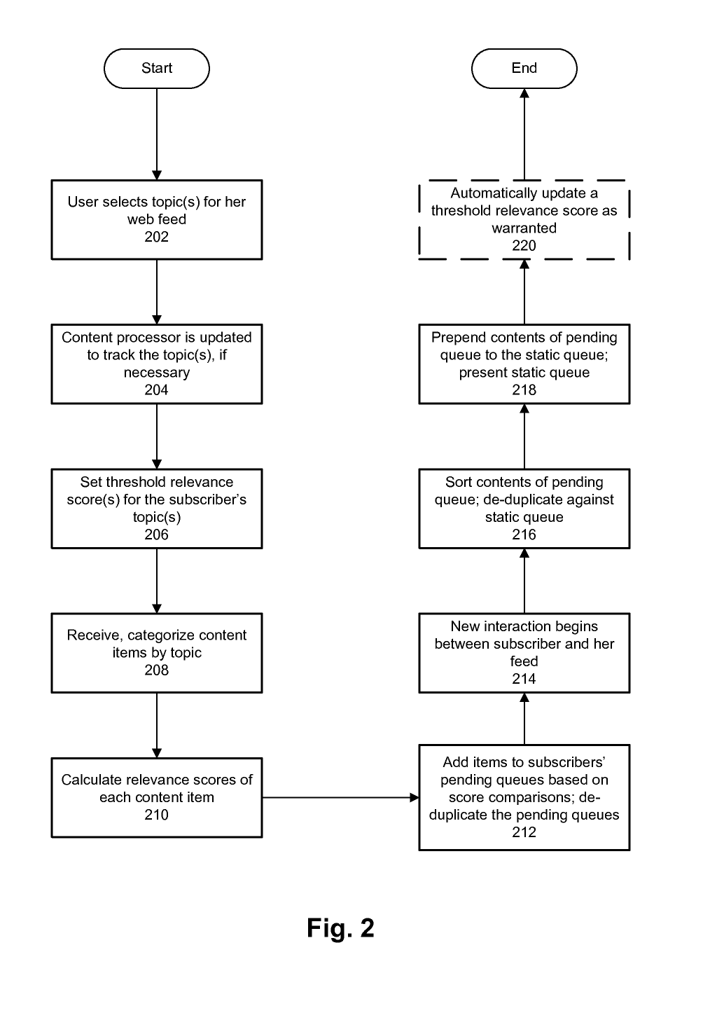

FIG. 2 is a flow chart illustrating a method of configuring a web feed for a subscriber, according to some embodiments.

In operation 202, the subscriber (or user or member) of a service or system that provides the web feeds selects one or more topics for which she would like to receive corresponding content items. In the illustrated method, feed topics are people (e.g., personal names), although in other embodiments they may be organizations, places, events, or other things. Thus, the subscriber identifies one or more people, thereby indicating that she would like her web feed populated with content items that mention or refer to those people.

In operation 204, a content processor, natural language processing module, or other appropriate system component is updated with the subscriber's topic choice(s). If the content processor is not already configured to track and identify content items that mention or refer to any of these choices, it will now be configured to do so. If however, the system is already tracking the selected people, it may simply add the subscriber to a list or list(s) of users who desire content items that correspond to these people.

In operation 206, a threshold relevance score is selected or calculated for use in filtering pertinent content items. Although this method is described as using one threshold relevance score for some or all of the subscriber's topics, in other embodiments multiple threshold relevance scores may be set (e.g., one for each topic, one for each content source).

As described above, this operation may involve examining various social media sites, services, and systems; determining relationships between the subscriber and the topic individual(s) within online systems; retrieving or obtaining the subscriber's preferences regarding how many items she would like to receive (e.g., per day, per week, per month) for one or more topics; retrieving historical data identifying pertinent metrics of content items previously received for the subscriber's topic(s) (e.g., average relevance score, standard deviation, average number of mentions of a topic within its corresponding items); and/or other information.

The various factors that affect the threshold relevance score may be combined in some manner, so as to make the threshold relevance score inversely proportional to the strength of known social connections between the topics—such as the average connection strength or, in an embodiment in which each topic has a separate threshold relevance score, the actual connection strength. Thus, if she follows a topic or subscribes to a topic's (a person's) social messages, and also likes that topic on a social media site, but there is no evidence of direct communication or a bidirectional relationship between her and the topic person, a relatively high threshold relevance score (or a relatively high range or magnitude of score) may be set. But, if she and the topic individual are friends on one (professional) social networking site, and are 2^{nd} degree connections on another social networking site, then a lower threshold score may be called for. Or, an even lower threshold relevance score may be warranted if they are friends on the social networking site and 1^{st} degree connections on a professional networking site. Thus, not only the existence of a connection between a user and a topic individual may be considered in setting a threshold relevance score, and the environment of the connection (e.g., which social application or service), but also the weight or strength of the connection (e.g., 1^{st} degree, 2^{nd} degree).

The threshold relevance score may take the form of a number of standard deviations of the average relevance of content items corresponding to the subscriber's topics. Thus, a relatively high threshold relevance score may require a given content item's relevance score to be four or five standards of deviation above the average in order to make it into the subscriber's feed. A relatively low threshold relevance score may only require a given item's relevance score to be two or three standards of deviation above the average in order to be included in the feed.

In operation 208, the web feed system receives content items in electronic form from various online sources, and categorizes them by topic. As described in U.S. patent applications Ser. Nos. 14/565,158 and 14/565,165, this process may involve identifying some or all people mentioned in an item, disambiguating among multiple people having the same name, and/or other action. This operation may be performed by a content processor that includes appropriate natural language processing capabilities.

In operation 210, relevance scores are generated for each processed content item to provide a measure of how relevant the item is to the topic with which it has been associated. This operation may be performed by a content processor and/or by a separate component, such as indexer 138 of FIG. 1. Operations 208 and 210 may continue to repeat throughout the method illustrated in FIG. 2.

In operation 212, for each content item that has been processed and for which a relevance score has been calculated, the system determines which subscribers have subscribed to or selected the corresponding topic for their feeds. And, for each such subscriber, the system compares the item's relevance score to the subscriber's threshold relevance score (i.e., the subscriber's threshold relevance score that applies to the topic). If the item's relevance score exceeds the threshold score (or possibly if the scores are equal), the item is placed in the subscriber's pending content queue.

Also in operation 212, items in a subscriber's pending queue may be de-duplicated. Illustratively, when a new item is to be added to her pending queue, the system determines whether it would be a duplicate of any other item in the pending queue. This may involve checking whether the new item is part of (or will be added to) a cluster that is already represented in the pending queue. If so, all but one are removed, with the one that is retained possibly being the ‘best’ one (e.g., the one with the highest relevance score), the longest or largest one (i.e., the one with the most content), the newest one, etc.

In operation 214, an interaction is initiated between a subscriber and her web feed. For example, the system may begin generating a message via electronic mail or other means to convey recent feed items to the subscriber. Or, the subscriber may log into the web feed site or system, in which case she will be shown or offered an updated view of her feed.

In operation 216, the contents of the subscriber's pending queue are sorted (e.g., according to relevance score) and de-duplicated against her static queue, to remove items from the pending queue that are duplicates of (e.g., in the same cluster as) items in the static queue.

In some embodiments, the sorting process involves identifying topics that are represented in the pending queue (i.e., the topics for which at least one corresponding content item is in the queue), selecting for each represented topic the item having the highest relevance score, and sorting the selected items by date (e.g., date of publication). For each day, the items may be sorted in inverse order of fame (i.e., the item(s) corresponding to least famous person are listed first). Items that are not the top-rated item for their corresponding topics may be dropped from the queue or may be presented after the top-rated items.

In operation 218, the items in the pending queue are presented to the subscriber (e.g., online or in a message) and are also prepended to the subscriber's static queue. In some embodiments, content sent to a subscriber via message includes only new items (i.e., those items that were prepended to the static queue). In contrast, if the user interacts online with her feed, the new items and the previous items (e.g., her entire new static queue) may be presented together.

In optional operation 220, a threshold relevance score for a subscriber is updated automatically based on her behavior, an explicit request from her, evolution of a topic (e.g., average relevance score, standard deviation) or a connection between the subscriber and the topic, etc. For example, if she only rarely opens content items corresponding to a particular topic, and especially if a relatively large number of items are presented to her for that topic, the applicable threshold relevance score may be increased.

In contrast, if she always opens items corresponding to another topic, or even searches for additional corresponding items that were not included in her feed (e.g., via a search tool offered online with the system), the applicable threshold relevance score may be decreased.

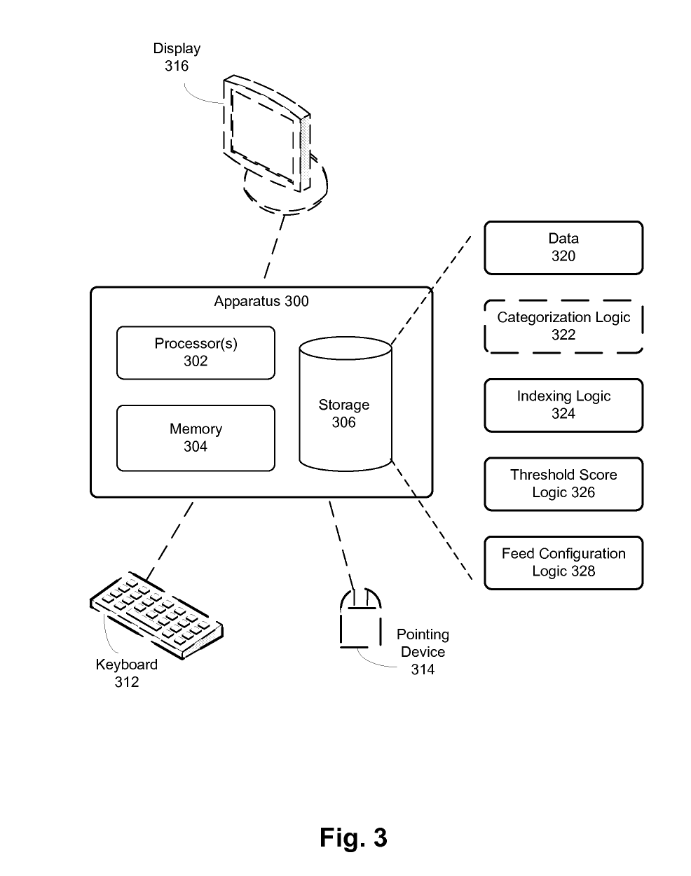

FIG. 3 is a block diagram of an apparatus for configuring a web feed, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316. In some embodiments, multiple apparatuses 300 operate cooperatively or in parallel.

Storage 306 stores data 320 related to content sources, topics, content items, user/subscribers, and/or other things. Content source data includes identities of various sources from which content items are (or have been) received, quality scores of those sources, a blacklist (and/or whitelist) of sources, etc. Topic data identifies topics selected or subscribed to by users, other available topics that have not been subscribed to (if any), and metrics regarding topics. Metrics that are retained regarding a given topic may include the average relevance score of corresponding content items, the standard deviation of the items' relevance scores, the average number of times each corresponding item mentions or references the topic, and/or other information.

Data regarding content items may include sizes of known clusters; linguistic analyses of items (e.g., for use in identifying clusters)—such as word counts, word/phrase frequencies, and so on; relevance scores; etc. Data regarding users may include the topics they have subscribed to, their threshold relevance scores for filtering content items, information for communicating with them (e.g., addresses, usernames), observations regarding their behavior regarding content in their feeds, observations regarding their use of social media and relations with other people and organizations, etc.

Storage 306 also stores logic that may be loaded into memory 304 for execution by processor(s) 302. Such logic includes optional categorization logic 322, indexing logic 324, threshold relevance score logic 326, and feed configuration logic 328. In other embodiments, these logic modules may be combined or divided to aggregate or separate their functionality.

Optional categorization logic 322 comprises processor-executable instructions for categorizing content items or, in other words, identifying the topic or topics of a content item. Categorization logic 322 is optional for apparatus 300 because in some embodiments an entity other than apparatus 300 may categorize content items (e.g., a content processor, a third party). Categorization logic 322 may also calculate relevance scores for content items as, or after, they are categorized.

Indexing logic 324 comprises processor-executable instructions for calculating the relevance score of each content item with regard each topic that has been associated with the item, if the score was not already calculated (e.g., by categorization logic 322). For each topic of a given content item, the indexing logic also identifies users that have subscribed to the topic, then compares the item's relevance score regarding that topic to each user's applicable threshold relevance score. If the given item's relevance score exceeds the threshold relevance score, the item is added to the user's pending queue of feed content. If another item in the same content cluster as the given item is already in the pending queue, only one will be retained (e.g., the one with the highest relevance score, the newest one).

Threshold relevance score logic 326 comprises processor-executable instructions for computing users' threshold relevance scores, based on metrics regarding their subscribed topics, their personal behavior (e.g., interaction with their web feed, communication patterns), their relationships or familiarity with the topics to which they have subscribed, and/or other information. A threshold relevance score may be periodically (and automatically or manually) updated.

Feed configuration logic 328 comprises processor-executable instructions for configuring a user's web feed from items that correspond to the user's subscribed topic(s). In some embodiments, when the apparatus prepares to send a message to the user to communicate feed content, and/or when the user goes online to access feed content, the feed configuration logic opens the user's pending queue of content, sorts its items in some manner, removes any items that duplicate items in the user's static queue of content (e.g., items in the same cluster), and adds the pending queue items to the static queue.

In some embodiments, apparatus 300 performs some or all of the functions ascribed to one or more components of the system of FIG. 1, such as feed server 130.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method of configuring a web feed, the method comprising:
identifying a first content topic selected by a user;
computing a threshold relevance score for the first topic, based on:
an average relevance score of a plurality of content items corresponding to the first topic;
a standard deviation of the relevance scores of the plurality of content items; and
a target frequency for including in the web feed content items corresponding to the first topic; and
for each new content item corresponding to the first topic:
calculating a relevance score for the content item; and
adding the content item to the web feed only if the relevance score exceeds the threshold relevance score.

2. The method of claim 1, wherein the first topic is one of:
a person; and
an organization.

3. The method of claim 2, wherein computing the threshold relevance score is also based on:
an average number of times the first topic is mentioned in the plurality of content items.

4. The method of claim 2, further comprising determining the target frequency by:
identifying relationships between the user and the first topic in one or more social media services.

5. The method of claim 4, wherein determining the target frequency comprises:
increasing the target frequency in proportion to a number of relationships between the user and the first topic in the one or more social media services.

6. The method of claim 1, further comprising determining the target frequency by:
delivering to the user multiple versions of the web feed;
recording manipulation of the multiple versions of the web feed by the user, wherein the manipulation includes accessing multiple content items provided in the multiple versions of the web feed; and
identifying a frequency with which the user accesses, within the multiple versions of the web feed, content items that correspond to the first topic.

7. The method of claim 1, wherein said calculating a relevance score for a content item comprises:
quantifying a quality of a source of the content item;
identifying a number of times the content item mentions the first topic; and
calculating a cluster size of the content item.

8. The method of claim 1, wherein said adding comprises:
including the content item in a pending queue associated with the user; and
de-duplicating the content item against other content items in the pending queue;
wherein the pending queue is different than a static queue associated with the user, in which content items previously presented to the user are retained in the order the previously presented content items were presented.

9. The method of claim 8, further comprising:
preparing a new version of the web feed to present to the user;
de-duplicating each content item in the pending queue against content items in the static queue; and
sorting the content items in the pending queue according to (a) the relevance scores calculated for the content items and (b) topics corresponding to the content items, including the first topic.

10. An apparatus for configuring a web feed, comprising:
one or more processors; and
a non-transitory memory storing instructions that, when executed by the one or more processors, cause the apparatus to:
identify a first content topic selected by a user;
compute a threshold relevance score for the first topic, based on:
an average relevance score of a plurality of content items corresponding to the first topic;
a standard deviation of the relevance scores of the plurality of content items; and
a target frequency for including in the web feed content items corresponding to the first topic; and
for each new content item corresponding to the first topic:
calculate a relevance score for the content item; and
add the content item to the web feed only if the relevance score exceeds the threshold relevance score.

11. A system for configuring a web feed, comprising:
one or more processors;
a content topic module comprising a non-transitory computer-readable medium storing instructions that, when executed by the one or more processors, cause the system to identify a first content topic selected by a user;
a threshold relevance calculator module comprising a non-transitory computer-readable medium storing instructions that, when executed by the one or more processors, cause the system to compute a threshold relevance score for the first topic, based on:
an average relevance score of a plurality of content items corresponding to the first topic;
a standard deviation of the relevance scores of the plurality of content items; and
a target frequency for including in the web feed content items corresponding to the first topic; and
an indexer module comprising a non-transitory computer-readable medium storing instructions that, when executed by the one or more processors, cause the system to, for each new content item corresponding to the first topic:
calculate a relevance score for the content item; and
add the content item to the web feed only if the relevance score exceeds the threshold relevance score

12. The system of claim 11, wherein the first topic is one of:
a person; and
an organization.

13. The system of claim 12, wherein computing the threshold relevance score is also based on:
an average number of times the first topic is mentioned in the plurality of content items.

14. The system of claim 12, wherein the non-transitory computer-readable medium of the threshold relevance calculator module further stores instructions that, when executed by the one or more processors, cause the system to determine the target frequency by:
identifying relationships between the user and the first topic in one or more social media services;
increasing the target frequency in proportion to a number of relationships between the user and the first topic in the one or more social media services.

15. The system of claim 11, wherein the non-transitory computer-readable medium of the threshold relevance calculator module further stores instructions that, when executed by the one or more processors, cause the system to determine the target frequency by:
delivering to the user multiple versions of the web feed;
recording manipulation of the multiple versions of the web feed by the user, wherein the manipulation includes accessing multiple content items provided in the multiple versions of the web feed; and
identifying a frequency with which the user accesses, within the multiple versions of the web feed, content items that correspond to the first topic.

16. The system of claim 11, wherein said calculating a relevance score for a content item comprises:
quantifying a quality of a source of the content item;
identifying a number of times the content item mentions the first topic; and
calculating a cluster size of the content item.

17. The system of claim 11, wherein said adding comprises:
including the content item in a pending queue associated with the user; and
de-duplicating the content item against other content items in the pending queue;
wherein the pending queue is different than a static queue associated with the user, in which content items previously presented to the user are retained in the order the previously presented content items were presented.

18. The system of claim 17, further comprising a feed configuration module comprising a non-transitory computer-readable medium storing instructions that, when executed by the one or more processors, cause the system to:
prepare a new version of the web feed to present to the user;
de-duplicate each content item in the pending queue against content items in the static queue; and
sort the content items in the pending queue according to (a) the relevance scores calculated for the content items and (b) topics corresponding to the content items, including the first topic.

19. The system of claim 11, wherein the non-transitory computer-readable storage medium of the indexer module further comprises instructions that, when executed by the one or more processors, cause the system to:
receive the new items from a content processor and, with each new item, information identifying at least one topic of each new item, including the first topic; and
compare the relevance score of each new content item to the threshold relevance score.
